(19) United States
(12) Patent Application Publication
(10) Pub. No.: US 2017/0046954 A1
(43) Pub. Date: Feb. 16, 2017

(54) Yielding Stop Sign

(71) Applicant: Travis Owen Leversen, Whittier, CA (US)

(72) Inventor: Travis Owen Leversen, Whittier, CA (US)

(21) Appl. No.: 14/804,289

(22) Filed: Jul. 20, 2015

(51) Int. Cl. G08G 1/09; F21V 23/04; G08G 1/095; F21V 23/00

(52) U.S. Cl. CPC G08G 1/09; F21V 23/008; F21V 23/0407; F21V 23/001; G08G 1/095; F21Y 2115/10

(57) ABSTRACT

The yielding stop sign will incorporate the use of the flashing yellow (amber) light that will indicate to drivers that it is okay to proceed through a stop sign without having to stop. Similar to existing traffic lights, the yielding stop sign will incorporate already existing laws regarding the flashing yellow traffic light and allow drivers to proceed on their route with caution at night.

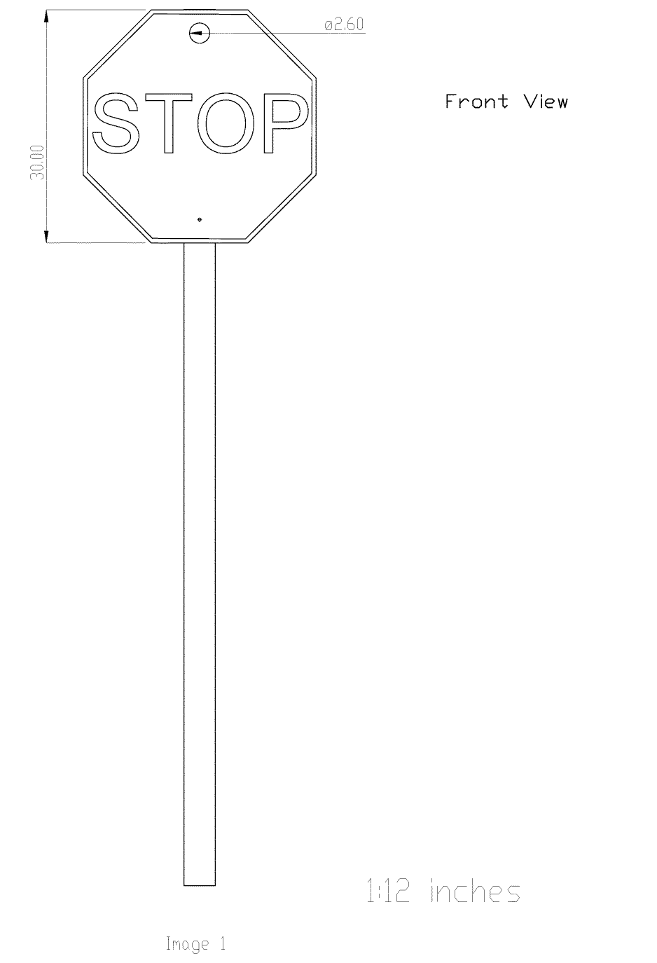

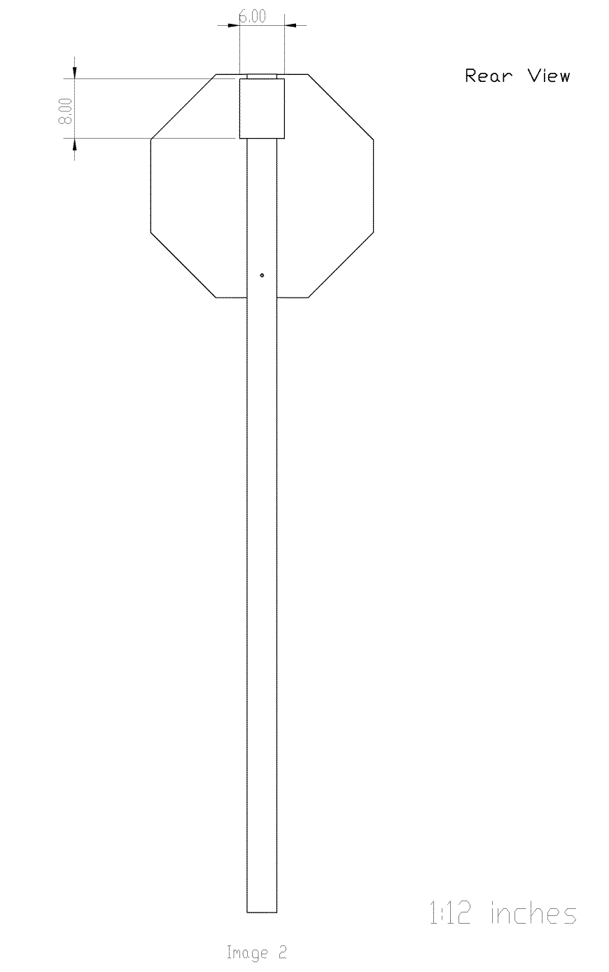

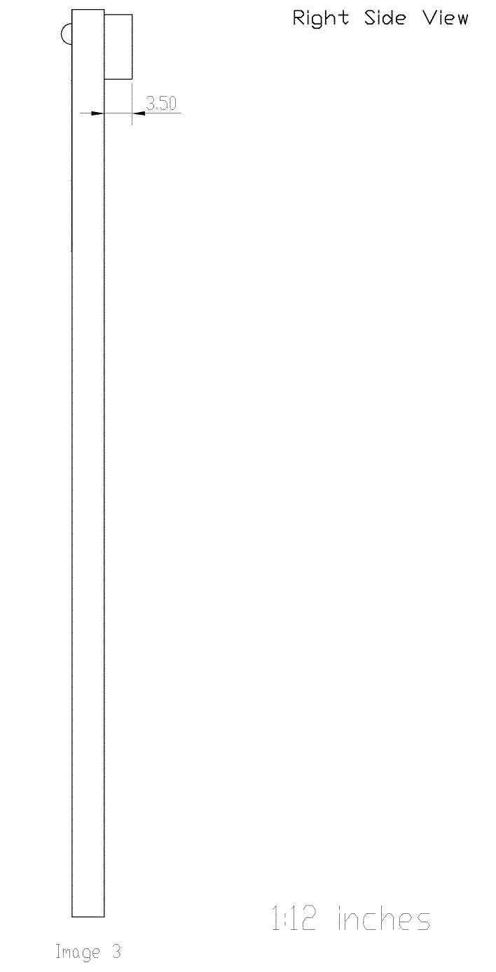

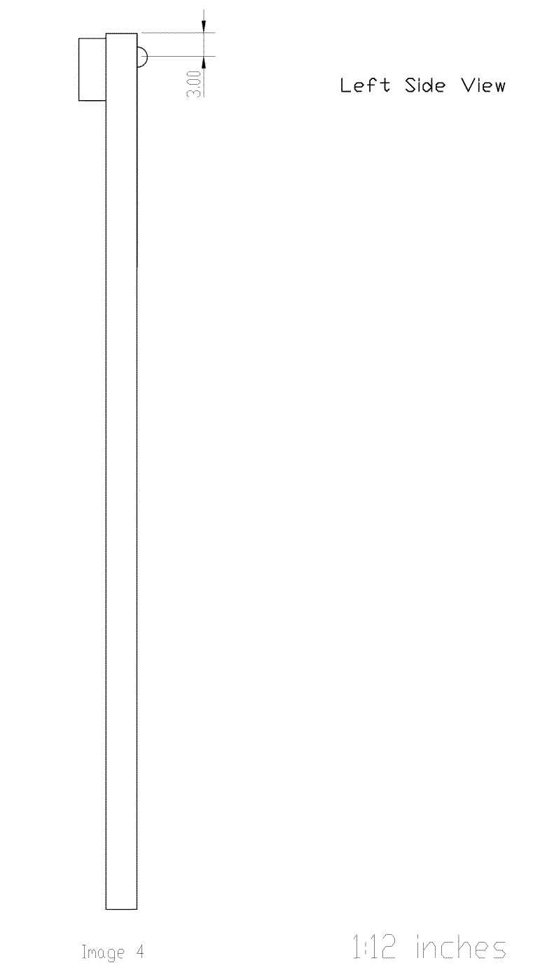

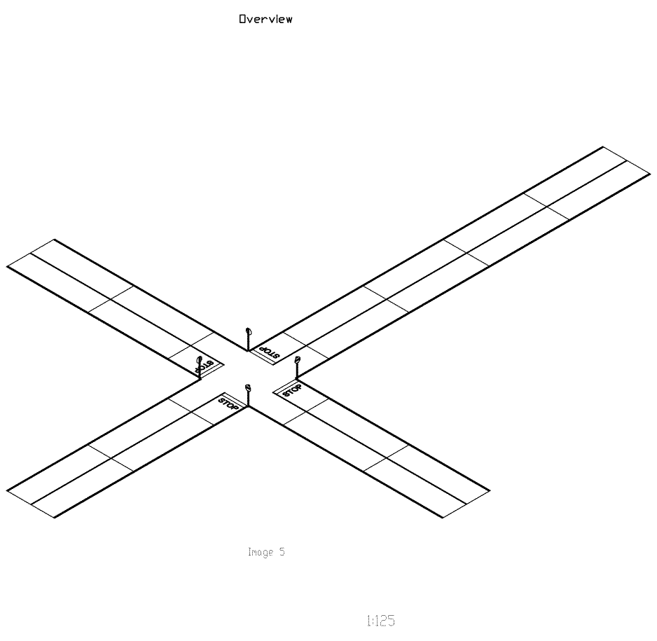

This invention utilizes an amber L.E.D. and housing to indicate to the driver that it is alright to proceed on their route. Previously drivers would have to perform a complete stop to continue on their journey and as a claim this light will eliminate any hesitation to slowly proceed with caution.

A solar panel or general ground outlet will be implemented and will utilize any available batteries to run the device. A solar cell or existing outlets will serve only as an additional source of power to help maintain the batteries longevity.

There is a housing or box that retains the small motors and devices that produce the lights desired effects. Within the box holds a battery, micro controller, voltage regulator, P.W.M. controller, and a photo cell light sensor with adjustment knob.

The power source is a 12V, 7 Amp/h battery cell. The micro controller runs a program designed to adjust the light frequency, brightness and timing, the basic properties of any light. The voltage regulator, regulates the voltage of the battery enabling it to run the micro controller at the needed lower power rate needed to prevent the micro controller from short circuiting. Within the box also contains a P.W.M. or pulse width modulation which regulates the power needed to control the frequency of power or brightness needed to enable the L.E.D. A photo cell is implemented with an adjusting knob to indicate the mechanism when to work and not to; specifically when the daylight begins to dim or when the sun begins to rise this machine will be able to tell itself to start or stop. All small electric devices will be enclosed inside of the housing, excluding the photo cell light detector and small cell solar panel, this box shall be remained closed upon any maintenance need.

### SUMMARY

The light will turn on after it is dark and will provide a driver a useful tool in the late night commute. This will save cities money by implementing a device to allow the same effect that some of our stop lights already produce with out having to construct one entirely. The light will produce a flashing yellow light mounted on a stop sign to enable the driver to incorporate his or her knowledge regarding the flashing yellow light and to proceed in any which direction safely.

A factory in San Diego or wherever else is readily available will collect all the parts and assemble them to the deigned specs and the finished product will then be shipped to the desired city or state, country or group that is willing to use the yielding stop sign. The first prototype was designed and built in Sacramento Calif. by a team of engineers Thomas and Andrew Kambe including myself on the weekend of Jun. 28, 2015. It is desired to start being used or implemented by the end of the summer, 2015 or earlier if possible.

### DETAILED DESCRIPTION

A driver comes along a lonely stop sign and in the back of is mind they think whats the trouble of “running” just this one? No one is around, its late, I am kinda of in a hurry, will I get in trouble, well the answer is yes! If he stops he'll feel glad that he did but still might have the thought that he could of made it but may feel the guilt in doing so. Thousands upon thousands do it every day wheres the sense in not helping out the process of running that stop sign and making it legal. The idea is to incorporate an already existing traffic law that is bypassed quite literally in certain parts of the world, I'm talking about the flashing yellow light. Stop signs have yet to incorporate this idea and a team of engineers and myself have devised a way to expand these ideals of the flashing yellow light and created the Yielding Stop Sign. This device uses a flashing yellow light capable of being mounted on a stop sign with out looking hideous, indicating to the driver that it is alright to proceed on through the crossroad. The device may or may not use a solar panel depending on the availability of electricity around the stop sign butt in all instances a battery is still deemed necessary in case of power outages.

Providing a safe alternative to traffic light construction, and a conservation of energy the Yielding Stop Sign is my gift to you.

### DRAWING DESCRIPTIONS

Image 1,

Consist of a front view of the applied product. We can see the stop sign and stop sign pole, but if you notice three inches down from the top of the stop sign you will find a circular light representing the yellow L.E.D. light that will be flashing.

Image 2,

Consists of a rear view of the housing holding the motor and other small mechanical devices. Dimensions of the box included.

Image 3,

Consists of a right side view, this shows us a better image of the total machine in use, we can see the light protruding form the stop sign and we can see the box mounted on the back of the stop sign pole. Dimension of the box included.

Image 4,

Consists of the left side view with the dimension of the light with respect to the distance from the top of the stop sign.

Image 5,

Consists of an overview of devices in position at a four way intersection.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. Indicating flashing yellow LED light.

15. An enclosed box containing parts described.

16. Wire for connecting parts.
